(19) United States
(12) Patent Application Publication
(10) Pub. No.: US 2025/0232238 A1
(43) Pub. Date: Jul. 17, 2025

(54) SYSTEM AND METHODS FOR DEEP LEARNING BASED RESILIENT SUPPLIER SELECTION AND ORDER ALLOCATION WITH UNCERTAIN DISRUPTIONS AND DEMAND

(71) Applicant: HITACHI, Ltd., Tokyo (JP)

(72) Inventors: Haiyan WANG, Fremont, CA (US); Ibrahim EL SHAR, Pittsburgh, PA (US); Atsuki KIUCHI, Tokyo (JP); Chetan GUPTA, Sunnyvale, CA (US)

(21) Appl. No.: 18/415,246

(22) Filed: Jan. 17, 2024

(51) Int. Cl. G06Q 10/0631; G06N 3/047

(52) U.S. Cl. CPC G06Q 10/06315; G06N 3/047

(57) ABSTRACT

Systems and methods described herein can involve, for an input of supplier features associated with one or more suppliers, supply chain network features and predicted demand features, processing the input through a trained deep learning model configured to intake the input and output primary supplier from the one or more suppliers, backup supplier from the one or more suppliers, order quantity for the primary supplier, and reservation capacity from the backup supplier; and executing a contract with the primary supplier and the backup supplier based on the order quantity and reservation capacity.

### BACKGROUND

### Field

The present disclosure is generally directed to supplier management systems, and more specifically, to deep learning-based approaches for supplier selection and order allocation.

### Related Art

For many industries, supplier selection and order quantity decisions are among the core of the company business operations. Supplier selection aims to select the best portfolio of suppliers and allocate optimal order quantities among these suppliers to meet downstream customer demands and company strategic goals.

In the related art, this process is based on a few evaluation criteria/metrics such as cost, quality, and delivery time. The Delphi method may be employed to aggregate opinions from a panel of experts iteratively and then reach a consensus to make the final decision.

Recent years have witnessed dramatic changes in many aspects of the global business environment. First, many companies' supply chains have become complex and extended thanks to global free trade. The resulting reliance on worldwide sourcing and diminished visibility to suppliers have led to significant uncertainty and disruptions on the supply side. Moreover, the boom of e-commerce in both industrial and consumer products has fostered massive small-scale manufacturers, making the competition in all product markets fiercer. The intense competition has also increased consumer expectations and shortened product life cycles drastically, resulting in highly dynamic and uncertain demand. Finally, many supply chains have faced more frequent and intense disruptions due to extreme weather events, geo-political crises, pandemic, and so on.

With the unprecedented uncertainties on both the supply and the demand side, the related art metric-based or deterministic optimization methods fail to take into account the actual business operating environment, and lead to suboptimal and non-resilient sourcing performance.

To incorporate uncertainties into the critical supplier selection and order quantity allocation decisions, researchers and supply chain practitioners have employed various stochastic modeling techniques such as multi-stage stochastic programming and chance-constrained programming. These related art methods usually rely heavily on a large number of potential scenarios of uncertain parameters involved on both the supplier and the customer demand sides. To have a good sourcing performance, the number of scenarios required usually goes exponentially with the number of uncertain factors, which are computationally expensive.

The above-mentioned related art methods especially fall short when the parameters of a supply chain change unexpectedly, and quickly adaptive decisions are required to gain competitive advantages. On the other hand, deep learning-based supplier selection and order allocation methods and decision support systems can allow organizations to have optimal and agile supply chain operations.

Deep learning is a subfield of machine learning based on artificial neural networks. Leveraging various architectures such as deep neural networks, recurrent neural networks, convolutional neural networks, transformers and deep reinforcement learning, deep learning has been applied to a wide range of fields, including computer vision, speech recognition, natural language processing, climate science, medical image analysis, and drug design. It has achieved results comparable and, in some cases, superior to human expert performance.

### SUMMARY

The supplier selection and order quantity allocation problem aims to select the best portfolio of suppliers and allocate optimal order quantities among these suppliers to meet downstream customer demands and company strategic goals. The problem is challenging because of various uncertainties involved in supply chain operations.

Traditional deterministic approaches ignoring uncertainties fail to satisfy customer demand when disruptions happen, and can thereby lead to sub-optimal performance. Related art stochastic programming-based methods rely on a large number of scenarios and have to solve large scale optimization problem every time when even a single parameter changes, which is computationally expensive and sometimes impractical. Hence, it will also result in suboptimal performance.

Because of the large amount of computation time required by the stochastic programming approach, it usually hinders many insightful analyses that may enable proactive actions, such as sensitivity analysis that can assess how the change in one parameter will impact the optimal supplier selection decisions, or what-if analysis that can enable proactive planning.

Example implementations described herein involve systems and methods for end-to-end deep learning based resilient supplier selection problem that can generate an optimal portfolio of suppliers in milliseconds whenever one or more parameters of the optimization problem change. Our idea is to leverage the powerful function approximation capability of deep neural networks to learn the underlying mapping between supplier selection problem parameters and the optimal portfolio of suppliers selected. In addition to applying the learned neural network to optimize supplier selection, the example implementations use the learned neural network to conduct sensitivity and what-if analyses to enable proactive planning and actions.

Aspects of the present disclosure can involve a method, which can involve, for an input of supplier features associated with one or more suppliers, supply chain network features and predicted demand features, processing the input through a trained deep learning model configured to intake the input and output primary supplier from the one or more suppliers, backup supplier from the one or more suppliers, order quantity for the primary supplier, and reservation capacity from the backup supplier; and executing a contract with the primary supplier and the backup supplier based on the order quantity and reservation capacity.

Aspects of the present disclosure can involve a computer program, storing instructions which can involve, for an input of supplier features associated with one or more suppliers, supply chain network features and predicted demand features, processing the input through a trained deep learning model configured to intake the input and output primary supplier from the one or more suppliers, backup supplier from the one or more suppliers, order quantity for the primary supplier, and reservation capacity from the backup supplier; and executing a contract with the primary supplier and the backup supplier based on the order quantity and reservation capacity. The computer program and instructions can be stored on a non-transitory computer readable medium and executed by one or more processors.

Aspects of the present disclosure can involve a system, which can involve, for an input of supplier features associated with one or more suppliers, supply chain network features and predicted demand features, means for processing the input through a trained deep learning model configured to intake the input and output primary supplier from the one or more suppliers, backup supplier from the one or more suppliers, order quantity for the primary supplier, and reservation capacity from the backup supplier; and means for executing a contract with the primary supplier and the backup supplier based on the order quantity and reservation capacity.

Aspects of the present disclosure can involve an apparatus, which can involve, a processor, configured to, for an input of supplier features associated with one or more suppliers, supply chain network features and predicted demand features, process the input through a trained deep learning model configured to intake the input and output primary supplier from the one or more suppliers, backup supplier from the one or more suppliers, order quantity for the primary supplier, and reservation capacity from the backup supplier; and execute a contract with the primary supplier and the backup supplier based on the order quantity and reservation capacity.

### BRIEF DESCRIPTION OF THE DRAWINGS

FIG. 1 illustrates an example two-echelon network, in accordance with an example implementation.

FIG. 2 illustrates the two-stage stochastic programming formulation of the supplier selection and order allocation, in accordance with an example implementation.

FIG. 3 illustrates an example of an end-to-end deep learning method for supplier selection, in accordance with an example implementation.

FIG. 4 illustrates an example of the training data preparation, in accordance with an example implementation.

FIG. 5 illustrates the general steps to train the neural network, in accordance with an example implementation.

FIG. 6 illustrates an example flow for the application of a trained NN, in accordance with an example implementation.

FIG. 7 illustrates an example flow of the trained NN which can be also be used for sensitivity analysis, in accordance with an example implementation.

FIG. 8 illustrates examples of a plot of the optimal costs against the parameter, in accordance with an example implementation.

FIG. 9 illustrates an example flow for predicting the optimal portfolio of suppliers, in accordance with an example implementation.

FIG. 10 illustrates an example user interface, in accordance with an example implementation.

FIG. 11 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means or can be implemented through a desired algorithm. Example implementations as described herein can be utilized either singularly or in combination and the functionality of the example implementations can be implemented through any means according to the desired implementations.

The goal of supplier selection and order quantity allocation is to identify a resilient and cost-effective set of suppliers to satisfy downstream customer demand taking into consideration supplier capacity, contracting costs, potential disruptions, and demand uncertainty.

Each supplier may offer diverse types of contracts with different terms. For example, two major types are primary and backup contracts. When signing a primary contract with a supplier, the buyer company incurs a fixed contracting cost and is also committed to order certain quantity levels for each period during the planning horizon at a relatively lower unit cost offered by the primary supplier. When signing a backup contract, the company also incurs a fixed contracting cost. However, the company does not commit to order any quantity upfront. Instead, the company reserves a fixed amount of capacity for the planning horizon by paying a non-refundable reservation fee. If the company needs to access the reserved capacity during the planning horizon later, it will need to pay a usually relatively higher unit purchase cost.

When disruptions happen, a primary supplier may not be able to fulfill the order quantities at certain periods. In this case, the supplier will refund the buyer company the unfulfilled portion. On the other hand, suppliers who offer backup contracts usually implement certain resilience measures such as capacity fortification program and will ensure the buyer company access to the reserved capacity.

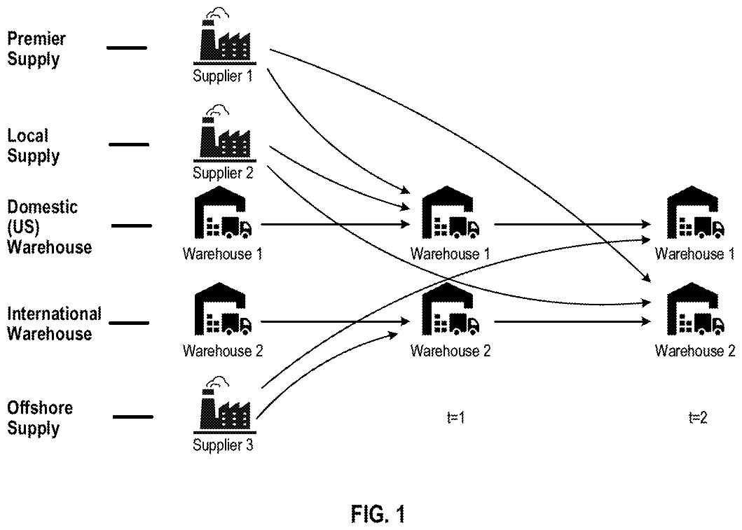

To illustrate the decision-making problem, take an abstracted two-echelon (i.e., two-stage) supply chain network as an example. The two-echelon network consists of suppliers and distribution centers or called warehouses where the aggregated demand from certain markets is satisfied. FIG. 1 illustrates an example two-echelon network, in accordance with an example implementation. In this example, it is assumed that the domestic warehouse (W1) and international warehouse (W2) serve as distribution centers for domestic market and offshore market, respectively. For domestic supply, consider the premier supplier (S1)—big corporations have multiple branches of factories/manufacturers located in varies locations; and local supplier (S2)—small business closer to domestic warehouse. On the other hand, offshore supplier (S3) is assumed to be located near international warehouse. Note that the lead time (procuring and transporting products from supplier to warehouse) is considerably longer for offshore transportation (i.e., S1-W2, S3-W1) than domestic/local logistics (i.e., S2-W1, S3-W2).

Consider the supplier selection optimization problem to satisfy a multi-period demand. While signing contracts with the suppliers (i.e., selecting suppliers), the buyer company does not know what will exactly happen in the multi-period planning horizon in terms of potential disruptions, suppliers' actual capacity, or customer demand, although it may have some high-level statistical knowledge. The statistical knowledge may be obtained from its internal historical data or external data sources.

This supplier selection with uncertainty problem can be solved using two-stage stochastic programming. Two-stage stochastic programming is a widely used optimization technique for decision-making under uncertainty. In practice, two-stage stochastic programming is usually implemented via a scenario-based approach—uncertain factors are represented as a finite set of scenarios, each depicting a potential realization of the uncertain parameters. These scenarios are incorporated into the two-stage model to develop robust and adaptive solutions that consider various possible outcomes.

The process involves two main components: formulation of the two-stage stochastic programming model and scenario generation.

The first stage decision variables include contracting suppliers and the allocation of orders among them. In the second stage, the model adapts the operational plans according to the actual conditions given the outcomes of the first stage decisions and the realized values of the uncertain parameters. The objective is to minimize the total cost of the first stage and the total expected of the second stage. In general, the uncertainties can arise from factors such as supply disruptions, demand variability, or fluctuating lead time and costs, and so on. A set of scenarios is generated to capture their possible realizations.

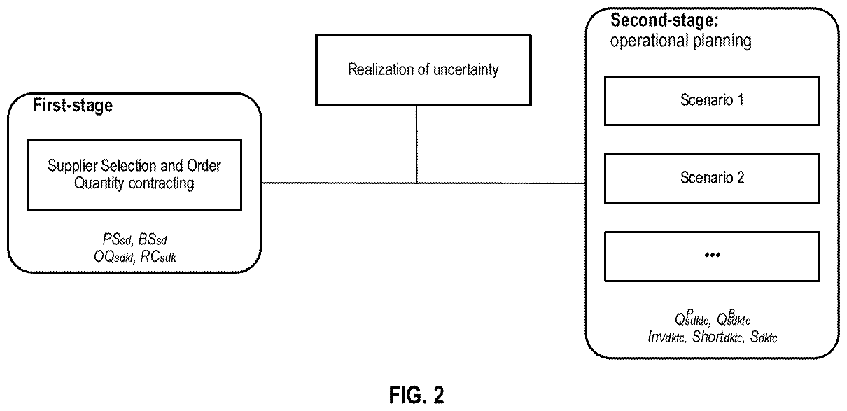

FIG. 2 illustrates the two-stage stochastic programming formulation of the supplier selection and order allocation, in accordance with an example implementation. Note that in the second stage, a multi-period supply chain operational model is considered where each period is characterized by its specific demands, production capacities, transportation connectivity status, inventory levels, and other relevant parameters. The dynamic nature of supply chain operations and the time-dependent aspects of decision-making are considered in the second stage.

The sets, indices, parameters, and variables used to formulate the problem mathematically are described below.

### Indices/Sets

See=Set of all scenarios (c∈Sce)
K=Set of commodities/materials (k∈K)
Nₛ=Set of candidate suppliers (s∈N)
N_{d}=Set of distribution centers (DC) (d∈N_{d})
T=Set of considered planning time periods (in some granularity) (t∈T)
Arcₜᵣₐₙₛ^{s}=Set of procurement and transportation arcs from suppliers to DC (s∈Nₛ, d∈N_{d})
Arcₜᵣₐₙₛ^{sm}=Set of procurement arcs of product k from spot market to DC (k∈K, d∈N_{d})
Arc_{disrupt}^{c}=Set of undisrupted arc from undisrupted supplier at time t of scenario c

### Parameters

The problem involves the following major parameters.

Supplier related parameters: Fixed contracting cost (primary/backup), Maximum production capacity for each product, Maximum capacity that can be reserved as backup, Unit capacity reservation cost, Unit purchase cost, and so on.

Transportation related parameters: Transportation lead time, Transportation cost rate, Demand fulfillment operations related parameters, Inventory holding cost rate, Demand shortage penalty cost, and so on.
FC_{sd}^{p}=Fixed cost for contracting supplier s as primary supplier for DC d
FC_{sd}^{b}=Fixed cost for contracting supplier s as backup supplier for DC d
proₛₖ=Maximum production capacity (in unit) of product k for suppliers ∈Nₛ
capₛₖ^{b}=Maximum capacity that can be reserved of product k for backup supplier s∈Nₛ
reservation_{sdk}=Unit reservation cost of product k from backup supplier to DC
ava_{sktc}=Available production capacity (in unit) of supplier s at time t for scenario c
trans_{sdtc}=Transportation connectivity at time t for scenario c
dem_{dktc}=Demand of product k at DC d at time t
LT_{sdt}=Lead time of purchasing and transporting products from supplier s to DC d
cost_{sdkt}^{p}=Procurement and transportation cost of product k from primary supplier at time t
cost_{sdkt}^{b}=Procurement and transportation cost of product k from backup supplier at time t
cap_{dktc}^{sm}=Available supply (in unit) of product k at spot market for DC (d∈N_{DC}) at time t
costₛₕₒᵣₜ^{dk}=Procurement and transportation cost of product k from spot market at time t
cost_{dk}^{short}=Shortage (Penalty) cost of product k at DC (d∈N_{DC})
cost_{d}^{inv}=Inventory holding cost at DC (d∈N_{DC})
Prob_{c}=Probability of scenario c∈Sce
Disruption_{sdtc}=1, if no disruption occurs; 0 if road connection is disrupted;
o.w, percentage of undisrupted production capacity.
M=a big number

### First Stage Variables (Binary & Continuous)

PS_{sd}=If a supplier s∈Nₛ is contracted as primary supplier for DC d∈N_{d} (Binary)
BS_{sd}=If a supplier s∈Nₛ is contracted as backup supplier for DC d∈N_{d} (Binary)
OQ_{sdkt}=Order quantity of product k from PS s∈Nₛ to DC d∈N_{d} at time t
RC_{sdk}=Reserved capacity of product k from BS s∈Nₛ to DC d∈N_{d}

### Second Stage Variables (Continuous)

Q_{sdktc}^{p}=Fulfilled (Actually shipment) quantity of product k by primary supplier at time t
Q_{sdktc}^{b}=Order quantity of product k fulfilled by reserved capacity from backup supplier at time t
Inv_{dktc}=Inventory level/unit of product k being prepositioned at DC d at time t
S_{dktc}=Spot market purchase of product k for DC at time t
Short_{dktc}=Shortage of product k at DC d at time t

### Objective Function

The objective function aims to minimize the total expected cost. The first-stage cost is comprised of i) fixed costs associated with the signing of a contract with a supplier as a primary supplier or backup supplier, ii) the total cost of ordering from the primary supplier, and iii) the total cost of reserving capacity from the backup supplier. The second stage cost encompasses the expected operational cost across all realized scenarios, that is, the costs of purchasing and shipment from the backup supplier and spot markets, inventory costs, penalty costs for shortages, and the refund from the disrupted primary supplier.

minimize Contracting cost, OQ and RC (stage 1)+Expected operational cost (stage 2) minimize

$${\sum }_{( s , d ) ∈ {Arc}_{trans}^{s}} {PS}_{sd} \times {FC}_{sd}^{p} + {\sum }_{( s , d ) ∈ {Arc}_{trans}^{s}} {\sum }_{k ∈ K} {\sum }_{t ∈ T} {OQ}_{sdkt} \times {cost}_{sdkt}^{p} + {\sum }_{s ( s , d ) ∈ {Arc}_{trans}^{s}} {BS}_{sd} \times {FC}_{sd}^{b} + {\sum }_{( s , d ) ∈ {Arc}_{trans}^{s}} {\sum }_{k ∈ K} {\sum }_{t ∈ T} {RC}_{sdk} \times {reservation}_{sdk} + {\sum }_{c ∈ Sce} {Prob}_{c} \times [ {\sum }_{( d , k ) ∈ {Arc}_{trans}^{sm}} {\sum }_{t ∈ T} {S}_{dktc} \times {cost}_{dktc}^{sm} + {\sum }_{k ∈ K} {\sum }_{t ∈ T} {Inv}_{dktc} \times {cost}_{d}^{inv} + {\sum }_{( s , d ) ∈ {Arc}_{trans}^{s}} {\sum }_{k ∈ K} {\sum }_{t ∈ T} {Q}_{sdktc}^{b} \times {cost}_{sdkt}^{b} - {\sum }_{( s , d ) ∈ {Arc}_{trans}^{s}} {\sum }_{k ∈ K} {\sum }_{t ∈ T} ( {OQ}_{sdkt} - {Q}_{sdktc}^{p} ) \times {cost}_{sdkt}^{p} + {\sum }_{k ∈ K} {\sum }_{t ∈ T} {Short}_{dktc} \times {cost}_{dk}^{short}$$

### Constraints

$$\begin{matrix}{\sum }_{d} {OQ}_{sdkt} \leq {pro}_{sk}^{p} & ∀ s , k , t\end{matrix} \qquad ( 1 )$$

$$\begin{matrix}{\sum }_{d} {RC}_{sdk} \leq {cap}_{sk}^{b} & ∀ s , k\end{matrix} \qquad ( 2 )$$

$$\begin{matrix}{Q}_{sdktc}^{p} \leq {OQ}_{sdk} \leq M \times {PS}_{sd} & ∀ ( s , d ) , k , t , c\end{matrix} \qquad ( 3 )$$

$$\begin{matrix}{Q}_{sdktc}^{b} \leq {RC}_{sdk} \leq M \times {BS}_{sd} & ∀ ( s , d ) , k , t , c\end{matrix} \qquad ( 4 )$$

$$\begin{matrix}{Q}_{sdktc}^{p} \geq {OQ}_{sdkt} \times {disruption}_{sdtc} & ∀ ( s , d ) , k , t , c\end{matrix} \qquad ( 5 )$$

$$\begin{matrix}{\sum }_{s} {Q}_{sdk ( t - {LT}_{sdt}^{p} ) c}^{p} + {\sum }_{s} {Q}_{sdk ( t - {LT}_{sdt}^{b} ) c}^{b} + {Inv}_{dktc} + {S}_{dktc} + {Short}_{dktc} \geq {Inv}_{dk ( t + 1 ) c} + {dem}_{dktc} + {Short}_{dk ( t - 1 ) c} & ∀ d , k , t , c\end{matrix} \qquad ( 6 )$$

$$\begin{matrix}{\sum }_{d} {Q}_{sdktc}^{p} \leq {ava}_{sktc} & ∀ s , k , t , c\end{matrix} \qquad ( 7 )$$

$$\begin{matrix}{\sum }_{k} ( {Q}_{sdktc}^{p} + {\sum {Q}_{sdktc}^{b}}_{k} \leq M \times {trans}_{sdtc} & ∀ s , d , t , c\end{matrix} \qquad ( 8 )$$

$${S}_{dktc} \leq {cap}_{ktc}^{sm} \qquad ( 9 )$$

$$\begin{matrix}{PS}_{sd} , {BS}_{sd} ∈ [ 0 , 1 ] & ∀ s\end{matrix} \qquad ( 10 )$$

$$\begin{matrix}0 {Q}_{sdkt} \geq 0 & ∀ s , d , k , t\end{matrix} \qquad ( 11 )$$

$$\begin{matrix}{RC}_{sdk} \geq 0 & ∀ s , d , k\end{matrix} \qquad ( 12 )$$

$$\begin{matrix}{Q}_{sdktc}^{p} , {Q}_{sdktc}^{p} \geq 0 & ∀ s , d , k , t , c\end{matrix} \qquad ( 13 )$$

$$\begin{matrix}{Inv}_{dktc} , {S}_{dktc} , {Short}_{dktc} \geq 0 & ∀ d , k , t , c\end{matrix} \qquad ( 14 )$$

Equation (1) guarantees that the quantity ordered from a primary supplier to all distribution centers (DCs) does not exceed the maximum production capacity during all planning periods. Similarly, equation (2) ensures that the total capacity reservation from a backup supplier for all DCs does not exceed its maximum capacity that can be reserved. To prevent purchase and shipment from non-contracted suppliers, equations (3) and (4) are implemented, where (3) further limits the actual shipment quantity from the primary supplier in the second stage to the quantity ordered in the first stage, while (4) restricts the order quantity made in the second stage from backup suppliers to the amount of capacity reserved in the first stage. Equation (5) ensures that the quantity ordered from a primary supplier in the first stage is fulfilled if no disruptions occur at time t. Equation (6) represents balancing constraints at DC for all periods and scenarios: at each time t, the total amount received from the contracted primary supplier and backup supplier, plus the inventory level, spot market purchase, and shortage, should be greater than or equal to the demand plus any excessive/prepositioned inventory for t+1, plus shortage/back order in time t−1.

To limit shipment from a primary supplier to its reduced production capacity due to disruptions, equation (7) is imposed. Equation (8) ensures the fulfillment of orders from any supplier, subject to road connection disruption. Equation (9) limits the amount of demand fulfilled via the spot market to market availability at time t. Finally, equations (10)-(14) represent bounds on variable values.

### Uncertainties and Scenario Generation

### Uncertain Actual Supplier Capacity at Each Period

During the operational/contract execution stage, suppliers may suffer production capacity disruptions for various reasons, such as part shortage, labor shortage, equipment breakdown, or natural disasters. That is, a supplier's actual production capacity may drop and fluctuate over time. Note that different suppliers may face different levels of risk as they have different geolocations and may have implemented different resilience measures. Similarly, suppliers may have different recovery capabilities and speeds after a disruption. To further complicate matters, a supplier's recovery process may be interrupted by another disruption.

To capture the interactions between the potential disruptions and the recoveries as well as the uncertain nature of disruptions and recoveries, one may model a supplier's capacity using a Discrete Time Markov Chain (DTMC) model. The states of DTMC present typical capacity levels that a supplier may have. The transition from lower capacity to higher capacity is governed by the recovery process while the transition from higher capacity to lower capacity is determined by the disruption process. Let i,j represent distinct possible capacity levels that supplier s may end up with at a certain period, p^{s}_{{i,j}} represent the transition probability from state i to state j. Then, supplier s's uncertain actual capacity level can be characterized by the state transition probability matrix {p^{s}_{{i,j}}}. This state transition probability matrix is supplier dependent as each supplier has its own reliability and resilience profile.

Denote the initial capacity level of supplier s at the beginning of the planning horizon as pros.

Each warehouse also faces uncertain demands over the planning horizon. To capture the correlation among demands during different periods, one may model the demands using Gaussian process. Specifically, for warehouse w, the demand vector for T periods [X^{w}ₜ_{₁}, X^{w}ₜ_{₂}, . . . , X^{w}ₜ_{_{T}}] follows a multivariate normal distribution N([μₜ_{₁}^{w}, μₜ_{₂}^{w}, . . . , μₜ_{_{T}}^{w}]Σw(Σₜ_{ᵢ}_{,t}_{ⱼ}, where [uₜ_{₁}^{w}, uₜ_{₂}^{w}, . . . , uₜ_{_{T}}^{w}] represents the mean demand vector and Σ^{w}(Σₜ_{ᵢ}_{,t}_{ⱼ}) is the covariance matrix.

To solve the optimization problem formulated using the stochastic programming approach, one has to generate a large number of scenarios (Set Sce) following the stochastic disruption and recovery processes of each supplier as well as the stochastic demand process of each warehouse. Each scenario involves the realizations of all uncertain parameters for the optimization problem, including the actual capacity level at each period for each supplier, as well as the actual demand at each warehouse at each period.

To generate the actual capacity level at each period for supplier s in a scenario, one can follow the standard Markov chain simulation using the state transition probability matrix {p^{s}_{{i,j}}} starting with the initial capacity level pros, i.e., sequentially generate a series of random variables conditioning on the previous one.

To generate the demand realization for a warehouse w in a scenario, one can apply the widely used method: 1) find the Choleskey decomposition A of the covariance matrix Σ^{w} (Σₜ_{ᵢ}_{,t}_{ⱼ}); 2) generate T i.i.d. standard normal variates z=[z₁, z₂, . . . , z_{T}]]; 3) calculate the sampled demand series during the planning horizon for warehouse w: dem_{w}=[uₜ_{₁}^{w}, uₜ_{₂}^{w}, . . . , uₜ_{_{T}}^{w}]+A* [z₁, z₂, . . . , z_{T}]

Once a large number N of scenarios have been generated, the large-scale optimization problem can be solved by using any out-of-box mixed integer programming (MIP) solvers such as CPLEX, Gurobi, and so on to find the first stage decision variable solutions to guide supplier selection and order quantity allocation.

If the conventional stochastic programming approach is relied upon to select suppliers, it will be computationally expensive when some parameter changes. Given the highly dynamic business environment in recent times, parameter change is ubiquitous. There may be two situations: 1) only parameters known at the epoch of selecting suppliers (called deterministic parameters) change, such as contracting cost, backup capacity reservation cost; 2) parameters of some stochastic processes change, such as suppliers' potential disruptions and recoveries, demand processes, and so on.

In the first situation, the large-scale optimization needs to be resolved again whenever one or more deterministic parameters change, which is usually computational expensive.

In the second situation, there is a need to first generate a large number of new scenarios, and then solve the new large-scale optimization problem to produce the new supplier selection solutions. Note that number of scenarios required grows exponentially with the number of suppliers in the network.

Because of the large amount of computation time required by the stochastic programming approach, it usually hinders many insightful analyses that may enable companies' proactive actions, such as sensitivity analysis that can assess how the change in one parameter will impact the optimal supplier selection decisions, what-if analysis that can enable proactive planning, and so on.

To overcome the challenge of re-optimization, example implementations described herein involve an end-to-end deep learning approach to generate the optimal supplier selection solution directly from the parameters or called features, which will be discussed in detail later. The offline learned neural network (NN) can solve the supplier selection problem in milliseconds. Moreover, the learned neural network can enable various analyses to generate valuable insights and enable proactive planning and actions.

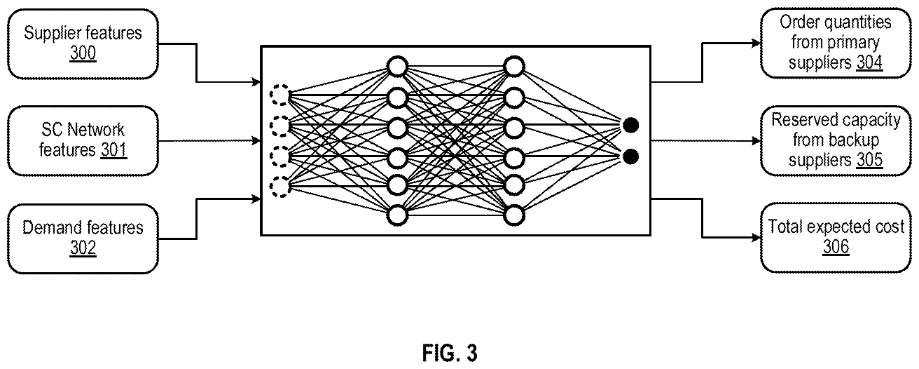

FIG. 3 illustrates an example of an end-to-end deep learning method for supplier selection, in accordance with an example implementation. The proposed method, as illustrated in FIG. 3, takes three main categories of features at input to a neural network: 1) supplier features 300; 2) supply chain (SC) network connection/transportation related features 301; and 3) demand features 302, and directly generates the optimal supplier selection decisions including the order quantities from each of the selected primary suppliers 304, the reserved capacity level from each of the selected backup suppliers 305, and the total expected cost 306.

The features that are used as input to the neural network are listed as follows:
1) Supplier features 300: for each supplier, there can be features such as capacity and cost. Capacity features can include maximum production capacity for each product, maximum capacity that can be reserved as backup, initial capacity level, potential capacity levels, and capacity level transition probability matrix {p^{s}_{{i,j}}}, and so on. Cost features can involve fixed contracting cost for primary contract, fixed contracting cost for backup contract, unit purchase cost for each product, unit capacity reservation cost.

2) SC network features 301: for each pair of origin (i.e., supplier) and destination (i.e., warehouse), there can be transportation lead time, transportation cost, and so on.

3) Demand related features 302: for each warehouse, there can be unit demand shortage penalty cost, unit inventory holding cost, mean demand vector over the planning horizon, demand covariance matrix, and so on.

The output of the trained neural network (NN) are the optimal supplier selection decisions and total expected SC cost 306, (i.e., the first stage decisions and the corresponding objective function value of the formulated optimization problem). Specifically, it can involve the order quantities from suppliers 304 (0 represents not signing primary contract with a supplier), the reserved capacity from suppliers 305, the total expected SC cost 306, and so on.

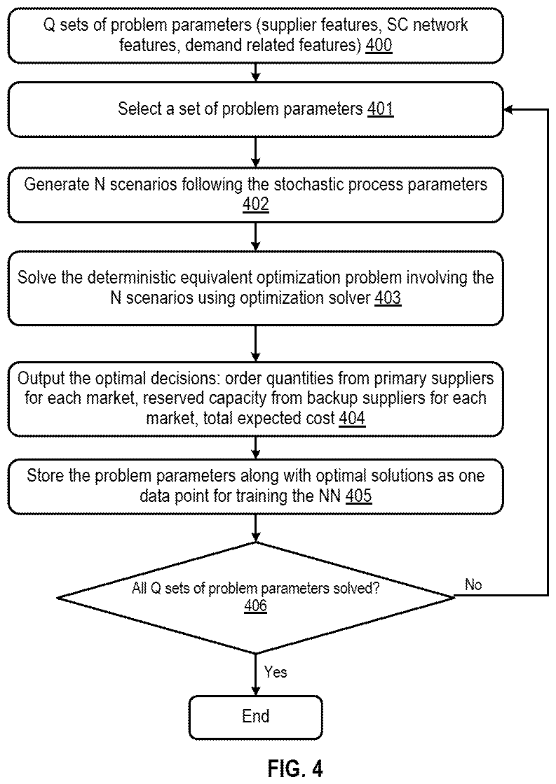

FIG. 4 illustrates an example of the training data preparation, in accordance with an example implementation. There are two major steps to train a NN for supplier selection, one is to prepare training data and the other is to train the NN using the generated training data.

The major steps for preparing training data are as follows.

At 400, the flow generates Q sets of problem parameters based on historical data or other sources (e.g., demand forecasting system, expert predictions).

At 401, a set of problem parameters are selected. For each set of problem parameters (input data) including both deterministic ones (e.g., unit purchasing cost, contracting cost) and those related with various stochastic processes, the following is conducted:

At 402, the flow generates N scenarios following the stochastic processes including suppliers' actual capacity level stochastic process, demand from all markets using the methods described. At 403, the flow solves the deterministic equivalent optimization problem incorporating the N scenarios using any optimization solver such as CPLEX, Gurobi, GLPK, and so on. At 404, the flow outputs the optimal decisions, which can involve order quantities from primary suppliers for each market, reserved capacity from backup suppliers for each market, total expected cost, and so on.

At 405 the flow stores the optimal first-stage decisions and the objective function value as the output data corresponding to this set of problem parameters.

At 406, a determination is made as to whether all Q sets of problem parameters are solved. If so (Yes), then the flow ends, otherwise (No) the flow proceeds to 401 to select another set.

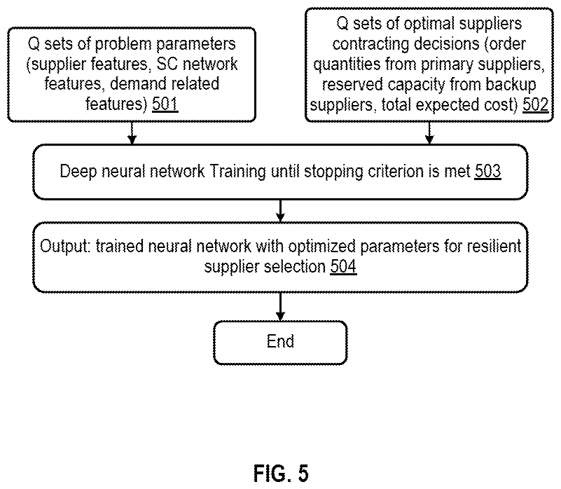

FIG. 5 illustrates the general steps to train the neural network, in accordance with an example implementation. The neural network may have diverse architectures and been trained using a variety of algorithms such as stochastic gradient descent (SGD), stochastic gradient descent with momentum, and so on. The flow can proceed as follows.

At 501 and 502, Q sets of problem parameters (e.g., supplier features, SC network features, demand related features) as well as Q sets of optimal suppliers contracting decisions (e.g., order quantities from primary suppliers, reserved capacity from backup supplier, total expected cost) are intaken for the deep neural network training 503 until a stopping criterion is met. Once trained, at 504, the output is a trained neural network with optimized parameters from resilient supplier selection.

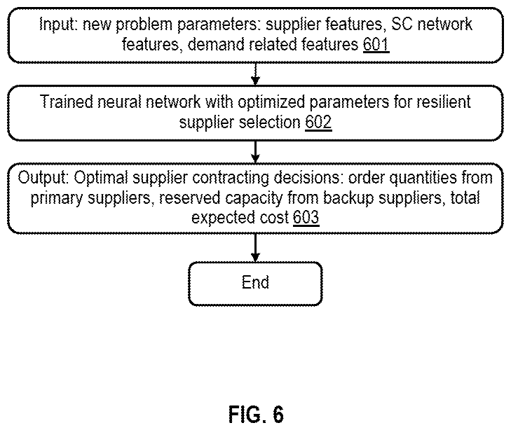

FIG. 6 illustrates an example flow for the application of a trained NN, in accordance with an example implementation. The trained neural network can be used to generate the optimal portfolio of suppliers with any set of new problem parameters, with the process illustrated in FIG. 6. At 601, an input is taken which involves new problem parameters (e.g., supplier features, SC network features, demand related features). At 602, the new problem parameters are processed through the trained neural network with optimized parameters for resilient supplier selection. At 603, the output is the optimal supplier contracting decisions (e.g., order quantities from primary suppliers, reserved capacity from backup suppliers, total expected cost, and so on).

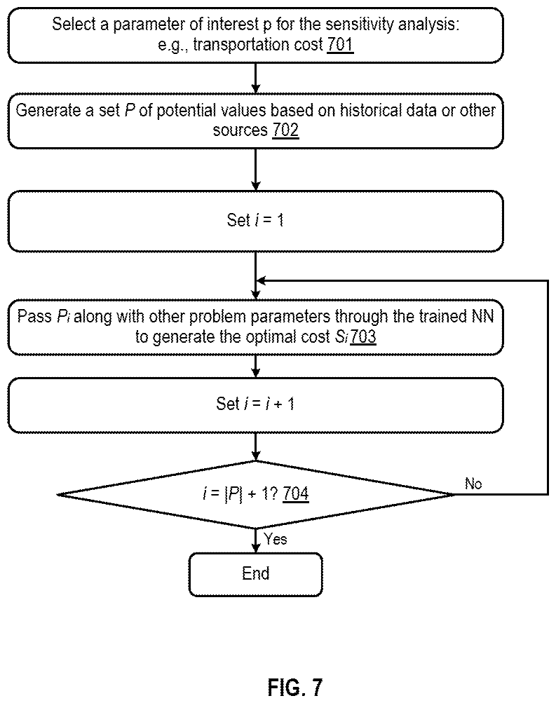

FIG. 7 illustrates an example flow of the trained NN which can be also be used for sensitivity analysis, in accordance with an example implementation. The trained NN can also be used for sensitivity analysis (i.e., analyze how decisions and total cost change when a particular parameter changes), as shown in FIG. 7. The flow can proceed as follows.

At 701, a parameter of interest p is selected for the sensitivity analysis (e.g., transportation cost). At 702, the flow generates a set P of potential values based on historical data or other sources.

A loop is then initiated by setting i=1. During the loop, Pi can be passed along with other parameters through the trained NN to generate the optimal cost Si at 703. The loop is then incremented (i=i+1). At 704, a determination is made if the loop should be terminated (e.g., such as whether i=|P|+1). If not (No), the flow proceeds back to 703, otherwise (Yes) the flow ends.

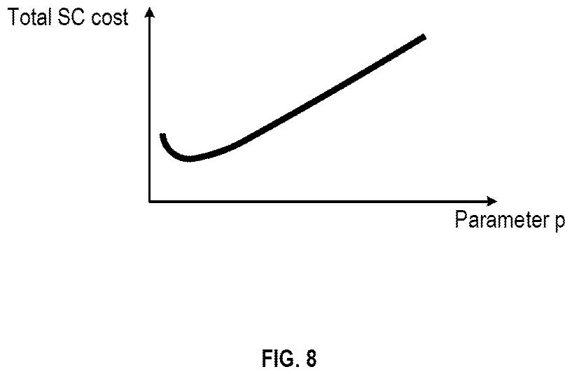

FIG. 8 illustrates examples of a plot of the optimal costs against the parameter, in accordance with an example implementation. The optimal costs Si can be plotted against the parameter pi, as shown in FIG. 8.

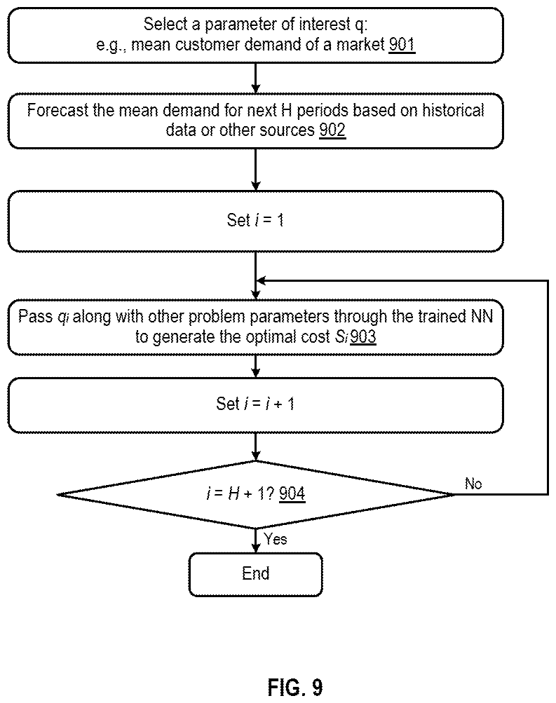

FIG. 9 illustrates an example flow for predicting the optimal portfolio of suppliers, in accordance with an example implementation. The example implementations described herein can also predict the trend of a particular parameter, and then pass the predicted parameter trend through the trained NN to predict optimal portfolio of suppliers, as depicted in FIG. 9. The flow can proceed as follows.

At 901, a parameter of interest q can be selected (e.g., mean customer demand of a market). At 902, the flow forecasts the mean demand for the next H periods based on historical data or other sources.

A loop is then formed by setting i=1. During the loop, the flow passes qi along with other problem parameters through the trained NN to generate the optimal cost Si. The loop is then incremented (e.g., i=i+1). At 904, a determination is made as to whether the loop should be terminated (e.g., i=H+1). If not (No), the flow proceeds to 903, otherwise (Yes) the flow ends.

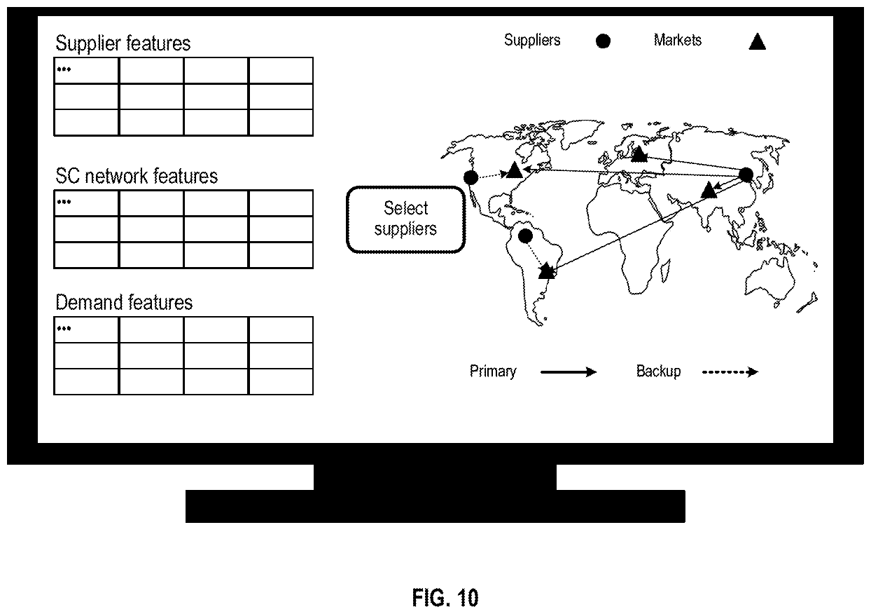

FIG. 10 illustrates an example user interface, in accordance with an example implementation. As illustrated in FIG. 10, supplier features, SC network features, and demand features can be displayed and selected/modified in accordance with the desired implementation. A map can also be provided for an input for suppliers to be selected (e.g., primary, backup), and the markets in question. The map interface shows which suppliers are selected as primary and which as backup. The user interface can show the optimal order and capacity reservation quantities from the primary and backup suppliers, respectively. It can also show the current and expected production capacity levels at each supplier. In case of a disruption, the interface can show the quantities to be ordered from backup suppliers.

The example implementations described herein consider uncertainties involved in future supply chain operations when contracting with suppliers and generate optimal portfolio of suppliers while the related art criteria-based and deterministic optimization-based methods fail to consider uncertainties and result in sub-optimal SC performance.

The example implementations described herein can quickly adapt to changing business environment and generate optimal set of suppliers in milliseconds whenever any of the parameters (e.g., market demand, supplier cost, supplier reliability, etc.) changes. Related art stochastic programming-based methods have to generate a large number of scenarios and then solve a large-scale optimization problem, which is computationally expensive.

The example implementations described herein can conduct efficient what-if analysis and sensitivity analysis to gain insights regarding how various parameters affect the supplier selection decisions and enable proactive actions, such as searching new suppliers or switching suppliers when certain parameters change or are projected to change.

Related art deterministic methods can not accurately assess the impact. Conventional stochastic programming-based methods are computationally expensive and impractical to conduct such analyses. The example implementations can also combine sensitive analysis and parameter trend prediction to predict and prepare for potential supplier switching.

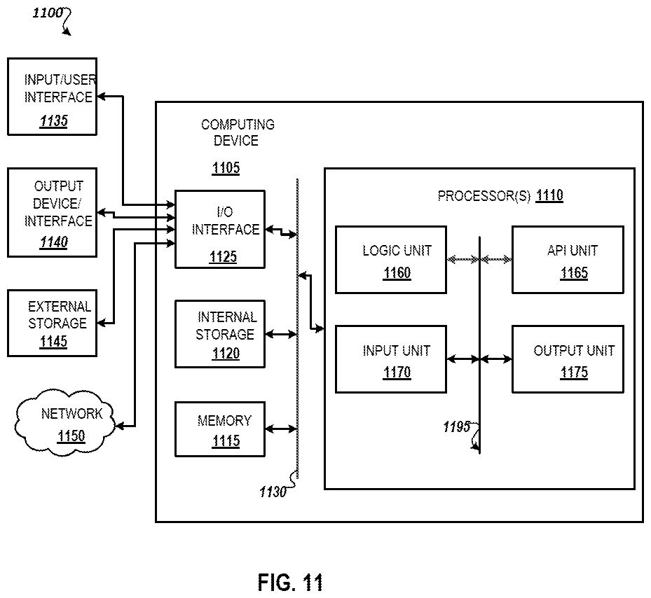

FIG. 11 illustrates an example computing environment with an example computer device suitable for use in some example implementations. Computer device 1105 in computing environment 1100 can include one or more processing units, cores, or processors 1110, memory 1115 (e.g., RAM, ROM, and/or the like), internal storage 1120 (e.g., magnetic, optical, solid-state storage, and/or organic), and/or IO interface 1125, any of which can be coupled on a communication mechanism or bus 1130 for communicating information or embedded in the computer device 1105. IO interface 1125 is also configured to receive images from cameras or provide images to projectors or displays, depending on the desired implementation.

Computer device 1105 can be communicatively coupled to input/user interface 1135 and output device/interface 1140. Either one or both of the input/user interface 1135 and output device/interface 1140 can be a wired or wireless interface and can be detachable. Input/user interface 1135 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 1140 may include a display, television, monitor, printer, speaker, braille, or the like. In some example implementations, input/user interface 1135 and output device/interface 1140 can be embedded with or physically coupled to the computer device 1105. In other example implementations, other computer devices may function as or provide the functions of input/user interface 1135 and output device/interface 1140 for a computer device 1105.

Examples of computer device 1105 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1105 can be communicatively coupled (e.g., via IO interface 1125) to external storage 1145 and network 1150 for communicating with any number of networked components, devices, and systems, including one or more computer devices of the same or different configuration. Computer device 1105 or any connected computer device can be functioning as, providing services of, or referred to as a server, client, thin server, general machine, special-purpose machine, or another label.

IO interface 1125 can include but is not limited to, wired and/or wireless interfaces using any communication or IO protocols or standards (e.g., Ethernet, 802.11x, Universal System Bus, WiMAX, modem, a cellular network protocol, and the like) for communicating information to and/or from at least all the connected components, devices, and network in computing environment 1100. Network 1150 can be any network or combination of networks (e.g., the Internet, local area network, wide area network, a telephonic network, a cellular network, satellite network, and the like).

Computer device 1105 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 1105 can be used to implement techniques, methods, applications, processes, or computer-executable instructions in some example computing environments. Computer-executable instructions can be retrieved from transitory media and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1110 can execute under any operating system (OS) (not shown), in a native or virtual environment. One or more applications can be deployed that include logic unit 1160, application programming interface (API) unit 1165, input unit 1170, output unit 1175, and inter-unit communication mechanism 1195 for the different units to communicate with each other, with the OS, and with other applications (not shown). The described units and elements can be varied in design, function, configuration, or implementation and are not limited to the descriptions provided. Processor(s) 1110 can be in the form of hardware processors such as central processing units (CPUs) or in a combination of hardware and software units.

In some example implementations, when information or an execution instruction is received by API unit 1165, it may be communicated to one or more other units (e.g., logic unit 1160, input unit 1170, output unit 1175). In some instances, logic unit 1160 may be configured to control the information flow among the units and direct the services provided by API unit 1165, the input unit 1170, the output unit 1175, in some example implementations described above. For example, the flow of one or more processes or implementations may be controlled by logic unit 1160 alone or in conjunction with API unit 1165. The input unit 1170 may be configured to obtain input for the calculations described in the example implementations, and the output unit 1175 may be configured to provide an output based on the calculations described in example implementations.

Processor(s) 1110 can be configured to execute a method or computer instructions, which can involve, for an input of supplier features associated with one or more suppliers, supply chain network features and predicted demand features, processing the input through a trained deep learning model configured to intake the input and output primary supplier from the one or more suppliers, backup supplier from the one or more suppliers, order quantity for the primary supplier, and reservation capacity from the backup supplier; and executing a contract with the primary supplier and the backup supplier based on the order quantity and reservation capacity as illustrated in FIG. 6. Depending on the desired implementation, a user interface such as a user interface as shown in FIG. 10 can be used to provide the output on a map and an option to execute the contract, whereupon the contract execution can be conducted through selection via the interface of FIG. 10.

Processor(s) 1110 can be configured to execute a method or instructions as described above, and further involve training the deep learning model, the training the deep learning model involving building and solving a two-stage stochastic programming with an objective of minimizing a total expected cost over a plurality of disruption scenarios generated based on the one or more suppliers, supply chain network, demand features extracted from historical data; wherein a first stage of the two-stage stochastic programming is configured to contract primary and backup suppliers, allocate orders to the primary suppliers and reserve capacity from backup suppliers, wherein the second stage of the two-stage stochastic programming is configured to adapt operational plans after disruption; executing a number of two-stage stochastic programming instances with different suppliers, supply chain network, and demand features to generate training data; and training the deep learning model from the training data as illustrated in FIGS. 2 to 5.

Processor(s) 1110 can be configured to execute a method or instructions as described above, wherein the supply chain network features involves an adjacency matrix pairing supplier to destination. Such features can be displayed on an interface as illustrated in FIG. 10, and the supply chain network features can involve supplier/destination pairs as described with respect to the equations.

Processor(s) 1110 can be configured to execute a method or instructions as described above, wherein the supplier features involve a probability transition matrix indicative of capacity transition that results from one or more disruption events and recovery process of the supplier as described with respect to the equations.

Processor(s) 1110 can be configured to execute a method or instructions as described above, and further involve periodically providing subsequent input to the trained deep learning model; and based on the output from the trained deep learning model from the subsequent input, updating a prediction of supplier cohort, necessity of changing the primary supplier, and necessity of increase of reservation capacity.

Processor(s) 1110 can be configured to execute a method or instructions as described above, and further involve, for receipt of another input of a parameter of interest, generating a plurality of values for the parameter of interest; processing the input with each of the plurality of values for the parameter of interest in the trained deep learning model to generate a plurality of the output for display as illustrated in FIG. 6 and FIG. 10. As additional new parameters are provided, they can also be provided through the trained deep learning model as described in FIG. 6 to FIG. 9.

Processor(s) 1110 can be configured to execute a method or instructions as described above, wherein for receipt of another input of a parameter of interest, forecasting future values of the parameter of interest for an upcoming period of interest based on historical data, and processing the future values of the parameter of interest through the trained deep learning model to determine another optimal primary supplier as shown in FIG. 6. Depending on the desired implementation, different primary suppliers can be provided through the interface as shown in FIG. 10 that can be more optimal than the current situation.

Processor(s) 1110 can be configured to execute a method or instructions as described above, wherein the input of the supplier features associated with one or more suppliers, the supply chain network features and the predicted demand features are received through a user interface configured to display locations of the one or more suppliers through a map as shown in FIG. 10.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method, comprising:
for an input of supplier features associated with one or more suppliers, supply chain network features and predicted demand features:
processing the input through a trained deep learning model configured to intake the input and output a primary supplier from the one or more suppliers, a backup supplier from the one or more suppliers, order quantity for the primary supplier, and reservation capacity from the backup supplier; and
executing a contract with the primary supplier and the backup supplier based on the order quantity and the reservation capacity.

2. The method of claim 1, further comprising training the deep learning model, the training the deep learning model comprising:
building and solving a two-stage stochastic programming with an objective of minimizing a total expected cost over a plurality of disruption scenarios generated based on the one or more suppliers, supply chain network, demand features extracted from historical data;
wherein a first stage of the two-stage stochastic programming is configured to contract primary and backup suppliers, allocate orders to the primary suppliers and reserve capacity from backup suppliers, wherein a second stage of the two-stage stochastic programming is configured to adapt operational plans after disruption;
executing a number of two-stage stochastic programming instances with different suppliers, different supply chain network, and different demand features to generate training data; and
training the deep learning model from the training data.

3. The method of claim 1, wherein the supply chain network features comprise an adjacency matrix pairing supplier to destination.

4. The method of claim 1, wherein the supplier features comprise a probability transition matrix indicative of capacity transition that results from one or more disruption events and recovery process of the supplier.

5. The method of claim 1, further comprising:
periodically providing subsequent input to the trained deep learning model; and
based on the output from the trained deep learning model from the subsequent input, updating a prediction of supplier cohort, necessity of changing the primary supplier, and a necessity of increase of the reservation capacity.

6. The method of claim 1, wherein for receipt of another input of a parameter of interest:
generating a plurality of values for the parameter of interest;
processing the input with each of the plurality of values for the parameter of interest in the trained deep learning model to generate a plurality of the output for display.

7. The method of claim 1, wherein for receipt of another input of a parameter of interest:
forecasting future values of the parameter of interest for an upcoming period of interest based on historical data;
processing the future values of the parameter of interest through the trained deep learning model to determine another optimal primary supplier.

8. The method of claim 1, wherein the input of the supplier features associated with the one or more suppliers, the supply chain network features and the predicted demand features are received through a user interface configured to display locations of the one or more suppliers through a map.

9. A non-transitory computer readable medium, storing instructions for executing a process, the instructions comprising:
for an input of supplier features associated with one or more suppliers, supply chain network features and predicted demand features:
processing the input through a trained deep learning model configured to intake the input and output a primary supplier from the one or more suppliers, backup supplier from the one or more suppliers, order quantity for the primary supplier, and reservation capacity from the backup supplier; and
executing a contract with the primary supplier and the backup supplier based on the order quantity and the reservation capacity.

10. The non-transitory computer readable medium of claim 9, the instructions further comprising training the deep learning model, the training the deep learning model comprising:
building and solving a two-stage stochastic programming with an objective of minimizing a total expected cost over a plurality of disruption scenarios generated based on the one or more suppliers, supply chain network, demand features extracted from historical data;
wherein a first stage of the two-stage stochastic programming is configured to contract primary and backup suppliers, allocate orders to the primary suppliers and reserve capacity from backup suppliers, wherein a second stage of the two-stage stochastic programming is configured to adapt operational plans after disruption;
executing a number of two-stage stochastic programming instances with different suppliers, different supply chain network, and different demand features to generate training data; and
training the deep learning model from the training data.

11. The non-transitory computer readable medium of claim 9, wherein the supply chain network features comprise an adjacency matrix pairing supplier to destination.

12. The non-transitory computer readable medium of claim 9, wherein the supplier features comprise a probability transition matrix indicative of capacity transition that results from one or more disruption events and recovery process of the supplier.

13. The non-transitory computer readable medium of claim 9, further comprising:
periodically providing subsequent input to the trained deep learning model; and
based on the output from the trained deep learning model from the subsequent input, updating a prediction of supplier cohort, necessity of changing the primary supplier, and a necessity of increase of the reservation capacity.

14. The non-transitory computer readable medium of claim 9, wherein for receipt of another input of a parameter of interest:
generating a plurality of values for the parameter of interest;
processing the input with each of the plurality of values for the parameter of interest in the trained deep learning model to generate a plurality of the output for display.

15. The non-transitory computer readable medium of claim 9, wherein for receipt of another input of a parameter of interest:
forecasting future values of the parameter of interest for an upcoming period of interest based on historical data;
processing the future values of the parameter of interest through the trained deep learning model to determine another optimal primary supplier.

16. The non-transitory computer readable medium of claim 9, wherein the input of the supplier features associated with the one or more suppliers, the supply chain network features and the predicted demand features are received through a user interface configured to display locations of the one or more suppliers through a map.

17. An apparatus, comprising:
a processor, configured to:
for an input of supplier features associated with one or more suppliers, supply chain network features and predicted demand features:
process the input through a trained deep learning model configured to intake the input and output a primary supplier from the one or more suppliers, backup supplier from the one or more suppliers, order quantity for the primary supplier, and reservation capacity from the backup supplier; and
execute a contract with the primary supplier and the backup supplier based on the order quantity and the reservation capacity.
